(19) United States
(12) Patent Application Publication
(10) Pub. No.: US 2012/0274604 A1
(43) Pub. Date: Nov. 1, 2012

(54) Capacitive Touch Sensor, Display or Panel

(76) Inventors: Stuart Alexander Norton, Kent (GB); Gabor Andras Pinter, Schutzen am Gebirge (AT)

(21) Appl. No.: 13/512,121

(22) PCT Filed: Nov. 26, 2010
(86) PCT No.: PCT/GB10/02186

§ 371 Date: May 25, 2012

(30) Foreign Application Priority Data
Nov. 27, 2009 (GB) 0920890.1

(51) Int. Cl. G06F 3/044

(52) U.S. Cl. 345/174

(57) ABSTRACT

There is disclosed a capacitive touch pad or device (10) which includes a substrate (12) and a plurality of capacilive pads (18) at an inner surface (16) of the substrate (12). Each pad (18) is provided with a local oscillator (22), the oscillation frequency of which varies with the capacitance of the capacitive pad (18). A micro controller (26) is operable to sense the oscillation frequency of the oscillators (22). In order to be usable in humid and wet environments, the microcontroller (26)operates on the basis of a time averaged signal from each of the oscillators (22) and compares this to a threshold, which threshold in the preferred embodiment is variable, for instance by time-averaging. The oscillators (22) is preferably close to the capacitive pads (18) in order to allow the use of a thicker substrate (12) and in the preferred embodiment a substrate which is waterproof. These arrangements provide a capacitive touch sensor device which can be used in humid or wet conditions.

The present invention relates to a capacitive touch sensor, display or panel, for use in humid or wet environments.

Capacitive touch sensors have gained wide popularity particularly in recent years as a result of their ease of use, elegant form, and ability to integrate readily into the electronics or other hardware of a device. Such sensors are used widely in modern portable telephones, touch screens of electronic devices, computer monitors and screens therefor and so on.

The vast majority of such sensors in use rely upon the moisture content of a user's finger to generate a change in capacitance at the zone of the sensor, this change being used as an indication of a command effected by the user. Given the high water content of a person's finger, this provides a reliable and efficient interface with the touch sensor, contributing to their significant popularity.

A problem arises, however, with such devices in that they are affected by humid environmental conditions. More specifically, if the devices are located or used in a highly humid or wet environment, the sensors of the device will register false signals causing the devices to operate incorrectly. As a result, the use of capacitive touch screens and displays based on capacitive touch sensors is generally avoided in all environments which may be highly humid or wet. For instance, although in recent times there has been a move to provide increasing amounts of electronic controls and entertainment systems in bathroom environments, for example, the inputs for these systems rely upon mechanical switches. This may be, for instance, by providing a separate keypad to a display screen which includes one or more waterproofed switches.

U.S. Pat. No. 4,954,823 discloses a method of rejecting a large change in external environmental capacitance over the majority of a capacitive keyboard and enhancing the sensitivity of prior systems.

U.S. Pat. No. 4,374,381 discloses a method of error correction that seeks to identify through multiple key scans and pass/discard operations changes in key status.

U.S. Pat. No. 4,924,222 discloses a method of high frequency oscillation to help penetrate thick substrates.

KR20090097983 discloses a method of operating a capacitive touch screen whereby electromagnetic interference is determined using an electromagnetic interference determination unit.

U.S. Pat. No. 3,696,409 discloses a system of capacitive key detection with oscillation circuits remote from the keys, low frequency operation and limited key rejection algorithms to discern event during transients.

The present invention seeks to provide an improved capacitive touch sensor system, an improved touch controller, an improved method of sensing capacitive inputs, and improved touch screen or display and an improved electronic device including a capacitive touch screen, display or input.

According to an aspect of the present invention, there is provided a device including a capacitive touch pad provided with at least one capacitive element for providing a control input to the device; and an oscillator associated with the or each capacitive element; wherein a change in capacitance at the capacitive element causes a change in oscillation frequency; the system including a control unit operable to measure the oscillation frequency of the or each oscillator; wherein the control unit is operable to derive a rolling average of the oscillator count, to derive a rolling average key threshold obtained from the rolling average of the associated oscillator count, to compare said rolling average oscillator count to said rolling average key threshold, and to determine therefrom whether an input has been effected.

The rolling average in this respect is the average value of the oscillator count, taken over a predetermined period of time prior to the present time. This time period, over which the average is taken, constantly changes as time proceeds. Thus the rolling average is effective to smooth out short-term fluctuations and highlight longer-term trends or cycles in the oscillator count. The time period over which the rolling average is taken is typically between 20 ms and 500 ms. In a particular example, the time period is 100 ms.

Advantageously, the rolling average key threshold is obtained from the rolling average of the oscillator count, instead of from the oscillator count directly.

The present invention can provide a system which is able to discern the difference between the wide variety of water events seen in a typical bathroom application, overcome soap/dirt films, cope with transient environmental conditions, reject false key presses, and allow automatic environmental adjustment, The present invention thus provides a mechanism by which reliable readings can be obtained from a capacitive touch sensor even in humid or wet environments. As a result, the preferred embodiments of the invention can provide displays, screens and touch panels which can be used in wet environments such as bathrooms, swimming pools, saunas, kitchens, outdoor applications and so on.

In particular, the preferred embodiments are able to provide user interfaces able to detect the presence of fingers but reject the presence of standing water droplets and running water.

Capacitive technology is ideal for wet-environments because it physically separates the electronics from the wet environment by projecting a capacitive field through a waterproof layer (tile, glass, etc).

Preferably, the control unit is operable to produce a variable threshold.

According to another aspect of the present invention, there is provided a A device including a capacitive touch pad provided with at least one capacitive element for providing a control input to the device; and an oscillator associated with the or each capacitive element and operating at a free running frequency of approximately equal to or greater than 8 MHz; wherein a change in capacitance at the capacitive element causes a change in oscillation frequency; the system including a control unit operable to measure the oscillation frequency of the or each oscillator; wherein the control unit is operable to derive a rolling average of the oscillator count, and to derive a rolling average key threshold from the rolling average of the associated oscillator count instead of from the oscillator count directly and to compare said rolling average oscillator count to a threshold, and to determine therefrom whether an input has been effected.

Advantageously, the control unit is operable to produce a variable threshold. In a preferred embodiment, the control unit is operable to produce a variable threshold obtained as a rolling average of the associated oscillator count. The rolling average of the variable threshold may be derived from the rolling average of the oscillator count, instead of from the oscillator count directly.

In the preferred embodiment, the or each oscillator is located adjacent to the or its respective capacitor pad. This avoids the problems of signal loss from the capacitive pads to the oscillators which can occur in prior art devices and also allows the use of thicker substrates or covers to the electronic circuitry, and thus panels which are more robust and waterproof.

Advantageously, the device includes a printed circuit board upon which the or each capacitor pad is located, the or each associated oscillator being coupled to the same circuit board as its respective capacitive pad.

In the preferred embodiment, the control unit is operable to determine an input based upon a change in capacitance at a plurality of capacitive pads of the device by determining a change in oscillation frequency of the associated oscillators.

According to a further aspect of the present invention, there is provided a device, such as an electronic device, telephone, computer, control panel and so on, the device including a capacitive touch pad, including a substrate that at least one capacitive pad located at an inner surface of the substrate and an oscillator located adjacent to the or each capacitive pad.

According to another aspect of the present invention, there is provided a method of operating a device including a capacitive touch pad provided with at least one capacitive element for providing a control input to the device; and an oscillator associated with the or each capacitive element; wherein a change in capacitance at the capacitive element causes a change in oscillation frequency; the system including a control unit operable to measure the oscillation frequency of the or each oscillator; wherein the method includes the steps of operating the control unit to derive rolling average of the oscillator count, operating the control unit to derive a rolling average key threshold obtained from the rolling average of the associated oscillator count, operating the control unit to compare said rolling average oscillator count to said rolling average key threshold, and operating the control unit to determine therefrom whether an input has been effected.

According to a further aspect of the present invention, there is provided a method of operating a device including a capacitive touch pad provided with at least one capacitive element for providing a control input to the device; and an oscillator associated with the or each capacitive element; wherein a change in capacitance at the capacitive element causes a change in oscillation frequency; the system including a control unit operable to measure the oscillation frequency of the or each oscillator; wherein the method includes the steps of operating the oscillator at a free running frequency of approximately equal to or greater than 8 MHz, and operating the control unit to derive a rolling average of the oscillator count and to compare said rolling average of the oscillator count to a threshold, and to determine therefrom whether an input has been effected.

Embodiments of the present invention are described below, by way of example only, with reference to the accompanying drawings, in which:

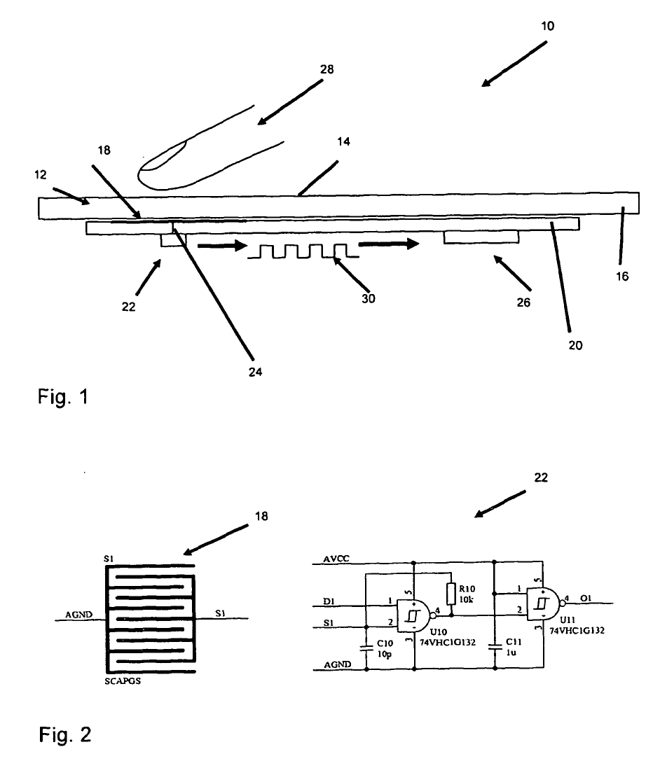

FIG. 1 is a side elevational view in schematic form of an embodiment of capacitive sensor device;

FIG. 2 is a circuit diagram showing the circuitry useful for the device of FIG. 1;

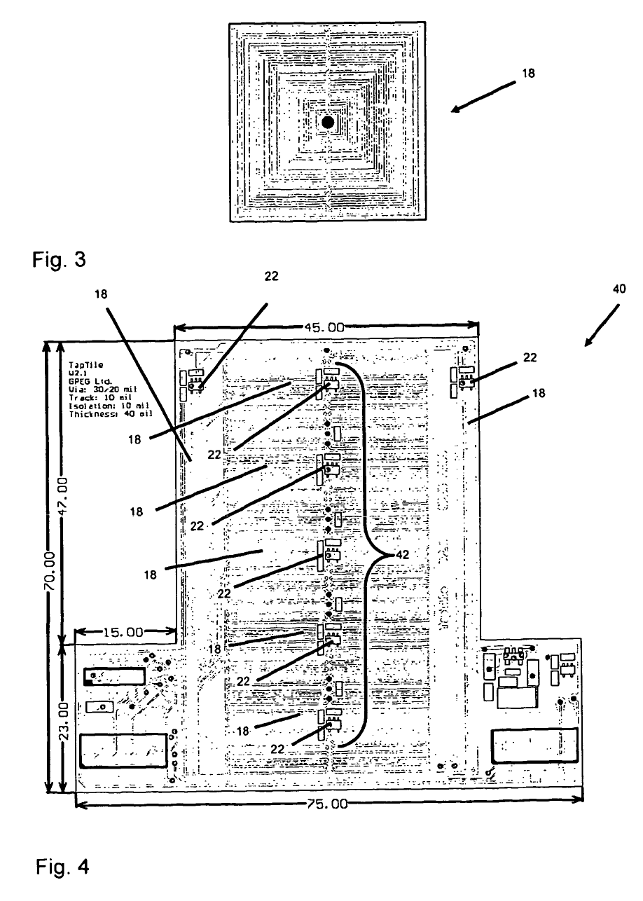

FIG. 3 is a plan view of a typical capacitive pad for use in the device of FIG. 1;

FIG. 4 is a plan view of an embodiment of device provided with an array of capacitive pads and associated oscillators;

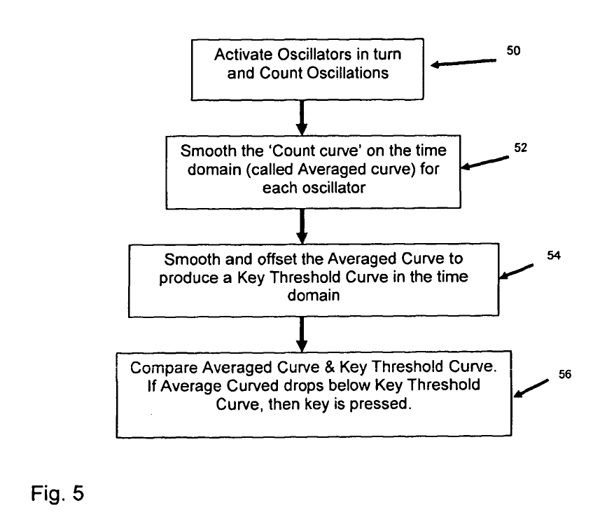

FIG. 5 is a flow chart showing the preferred embodiment of sensing process;

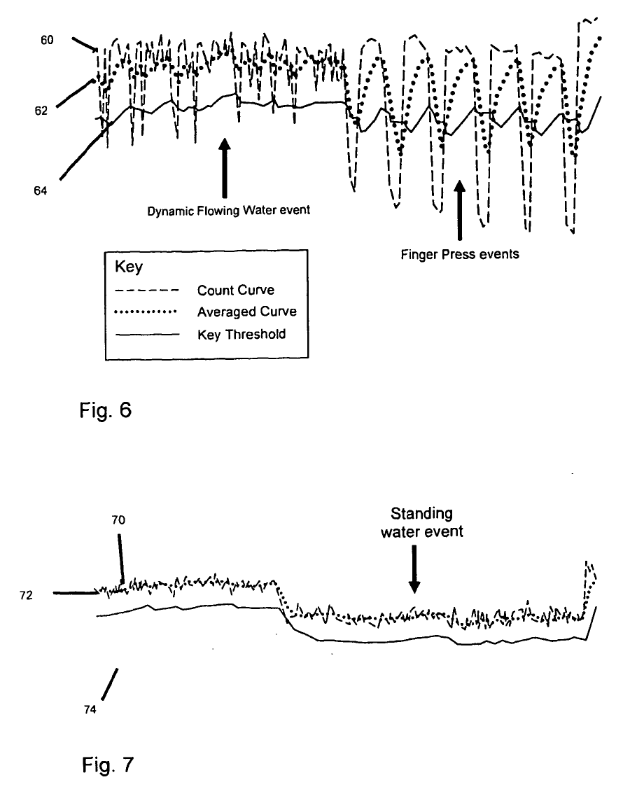

FIG. 6 is a graph showing the preferred arrangement for the rejection of unwanted dynamic events;

FIG. 7 is a graph showing the preferred arrangement for the rejection of unwanted static events; and

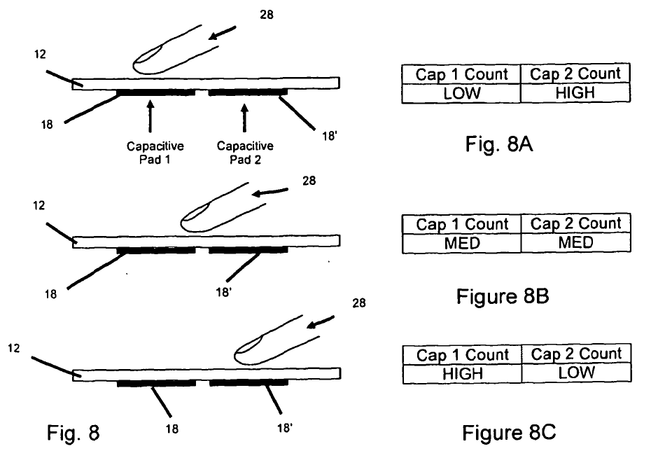

FIG. 8 shows how the sensor system can be used to determine real-time finger position.

Referring to FIG. 1, there is shown in schematic form a preferred embodiment of capacitive touch sensor system. The system is provided as a waterproof unit in which the electronic components of the device are either provided in a sealed casing or are able to be sealed into a waterproof casing and in connection with the latter option are arranged in the sensor system such a touch plate of the sensor system can be located for user operation and the electronics protected thereby.

The system 10 includes a substrate 12 which may be glass panel, although could be formed of any other material and may be a flat panel or curved. Similarly, although in the preferred embodiment the substrate 12 is generally rigid, in some applications it could be flexible.

The substrate 12 may be transparent, translucent or even opaque and will typically be provided with various indicia representative of the function performable by each sensor or button.

The substrate 12 has a user surface 14, hereinafter termed the upper surface, which faces a user and which may be waterproof or waterproofed by as waterproof layer (not shown). The substrate also has a component or internal surface, hereinafter termed the lower surface, which is opposite the upper surface. At the lower surface 16 there are provided a plurality of capacitive pads 18 (only one being shown in FIG. 1). In practice there would be one pad per function to be performed, that is one pad per “button” of the device 10. It is envisaged, however, that a plurality of capacitive pads 18 could provide more functions than the number of pads, that is that a “button” could be construed as a signal across two or more capacitive pads 18 and determined as such by way of analysis of the capacitance sensed at the affected capacitive pads.

Advantageously, the device 10 includes a circuit board 20 upon which the capacitive pads 18 and other circuit components are coupled, although in some embodiments the substrate 12 could act as the circuit board.

Coupled to each capacitive pad is an oscillator 22, the coupling being by means of a through-hole connector 22 in the board 20. The oscillator 22 is therefore local to the capacitive pad and coupled in the preferred embodiment to the same circuit board and no more than around 2 centimetres therefrom, preferably located directly behind the sensor pad.

The circuit also includes a microcontroller 26, which may be fitted to the circuit board 20 or could be provided on a separate circuit board (not shown) should this be preferable for a particular application. The microcontroller 26 is coupled to all of the oscillators 22 provided for the plurality of capacitive pads and is operable to control the outputs of the device 10. The microcontroller 26, which may include any suitable microprocessor available in the art.

Thus, in the preferred embodiment, each button is made up of a capacitive pad 18 and a simple oscillator circuit 22. The speed of the oscillator 22 is affected by the capacitance of the circuit, this capacitance is in turn determined by objects (such as a finger 28) within the electric field of the capacitive pad 18. By counting the change in number (frequency) of oscillations 30 of the oscillator 22, the microcontroller 26 can detect the presence of an object. Specifically, the microprocessor 22 is set up to scan the signals from the oscillators 22, that is of the ‘buttons’ of the device 10, by activating each oscillator 22 for a set period and counting the number of oscillations within that period.

The use of local oscillators 22 removes the problem of signal loss associated with some prior art capacitive sensor devices.

In the preferred embodiment the oscillators 22 have a simple structure, enabling them to be of compact and robust design and thus able to be located adjacent their respective capacitive pads 18. FIG. 2 is a circuit diagram of an embodiment of circuit for the oscillators 22. The components and their function will be apparent to the skilled person from FIG. 2.

The inventors have found that sensitivity of the system is dependent on the free running frequency of the oscillators 22, that is the frequency at which the oscillators operate in the absence of objects within the electric field of the capacitive pad 18. In addition to this, disruption is increased by the presence of contaminants (for example, salts or soap particles) in water on the surface 14 of the substrate 12. Somewhat surprisingly, the inventors have discovered that operation of the oscillators at a free running frequency of 8 MHz or greater substantially eliminates disruption caused by contaminants in the water.

Thus, operating the oscillators at a free running frequency of 8 MHz or greater results in system having the required sensitivity levels and which can operate in free air, clean water, dirty water, soapy films, and the like.

FIG. 3 shows an embodiment of capacitive pad 18. This is connected between ground AGND and supply and S1 of the oscillator circuit of FIG. 2. In one embodiment, it is a fine pitch, comb like pattern on the PCB, which is ideally at least as big as a finger.

Referring to FIG. 4, there is shown an example of touch pad 40 which is provided with a series of capacitive pads 18, some in a line 42 along the device 40 and others at other locations within the perimeter of the device 40. Each pad 18 has adjacent thereto a local oscillator 22 of the type described above. The arrangement of capacitive pads 18, and their associated oscillators 22, is chosen in dependence upon the design and function of the device 40 and it will be apparent that these locations can be chosen entirely in dependence upon the intended design of the device 40.

It will be apparent that in the preferred embodiments the devices 10, 40 will be substantially waterproof or kept in a waterproof casing such that access to the capacitive pads is still enabled. As with known capacitive sensors, when the devices 10, 40 are used in a wet environment, any water or moisture on the surface 14 of the substrate 12 will cause a change in capacitance at the pads 18 and thus a change in the frequency of oscillation of the oscillators 22, thereby in turn affecting the signals 30 produced by the oscillators 22. It is the manner in which the signals from the oscillators 22 are processed, described in detail below, which enables the devices 10, 40 to be controlled so as to be usable in wet environments.

Referring to FIG. 5, there is shown a flow chart of a preferred embodiment of signal processing method for use with the devices 10, 40. The method works not by making an immediate decision about key presses but to convert to the time-domain first and make the key-press decision based on at least two smoothed curves.

Specifically, the microcontroller 26 performs the following functions. At step 50 the microcontroller 26 activates each oscillator 22 in turn and counts the oscillations produced thereby within a set time period. The count contributes to a count curve for each oscillator, which represents the count reached each time the oscillator is activated for the predetermined period.

At step 52 the microcontroller 26 effects a smoothing function on the count curve for each oscillator 22 in the time domain, thereby to produce an averaged curve.

At step 54 the microcontroller 26 smoothes and offsets the averaged curve to produce a key threshold curve in the time domain and which is then used to determine the state of the oscillator in subsequent activations and thus the state of the ‘key depressions’. At step 56 the microcontroller compares the averaged curve with the key threshold curve. If the averaged curve drops below the key threshold curve, the microcontroller 26 determines that the key or button has been pressed. When the averaged curved is below the key threshold curve, the key threshold value is fixed until the averaged curve returns above it or a reset event is triggered.

Thus, instead of determining the state of the ‘button presses’ by detecting a change in capacitance at the capacitive pads 18 at a single activation of the associated oscillator 22, the system produces an averaged threshold level or value of the capacitance sensed and then compares this to a key threshold curve.

Although in the preferred embodiment the key threshold curve is itself an averaged threshold of the signals from an oscillator 22, it will be appreciated of a longer time period than the averaged curve, it is envisaged in some embodiments that the key threshold may be a fixed parameter (that is a fixed frequency count). Such an alternative can be useful in some applications, although it is generally preferred to have a variable threshold as this can take into account changes in what could be termed environmental conditions, such as background humidity in a room, temperature changes or standing water.

In a further embodiment, the microcontroller 26 can operate to sum some or all of the signals from the oscillators 22, to generate a rolling (time smoothed) average and a rolling (time smoothed) threshold. These averages are typically taken over a 100 ms period preceding the present time, although in alternative embodiments the length of the time period can be anything from 20 ms to 500 ms. This can be used to determine the presence of an abnormally large splash of water or flow of water, in which case the summed signals will exceed a sum threshold. The system reacts to lock the system, thus preventing the input of further key events. This is however not a permanent lock out, and the system will start to operate normally again after a lock out period, if the flow of water is determined to be at a reasonably constant level. This feature is also useful in detecting and blocking RF interference which might otherwise cause false key detection.

The actual function used in the preferred embodiment is an averaging function encapsulated in the following code:

```
#include <stdio.h>
#include <stdlib.h>
#include “typedefs.h”
unsigned long long average;
unsigned long long threshold;
unsigned long long temp1;
unsigned long long temp2;
unsigned long long temp3;
unsigned long long measurement;
signed long long diff;
signed long long tdiff;
float pc;
int rnd;
#define BASELINE 50000000ULL
#define FILTER 0x8000ULL // 50% of MAX...
#define THRES 0xFF40UL
#define ADAPT 0xC000UL //
#define F 0x10000ULL
void doaverage(void);
void dothrfollow(void);
int main(int argc, char **argv)
{
    int count;
    int diffcount;
    int lastdiff;
    int run;
    average = BASELINE;
    threshold = 0UL;
    measurement = BASELINE;
    diffcount = 0;
    lastdiff = 0;
    srand(14214469);
    printf(“avg = %Id thresh = %Id diff = %Id\n”, average, threshold,
    diff);
    count = 0;
    run = 1;
    do
    {
```

| | |
|---|---|
| count++; | // |
| How many times round the loop.... | |
| #ifdef JITTER | |
| // Add jitter to the measurement. | |
| rnd = rand( ); | // rnd = 0 |
| - A_BIG_NUM | |
| rnd &= 0xFF; | // rnd = 0 |
| - 0xFF | |
| 1 rnd −= 0x80; | // rnd − − |
| 127 - 128 | |
| measurement = BASELINE+rnd; | // Add the noise to |
| | measurement |
| #endif | |
| doaverage( ); | |
| diff = average − measurement; | |
| if(diff != lastdiff) | // Has the diff changed ?. |
| { | |
| lastdiff = diff; | // Yes, so remember last |
| | diff |
| diffcount = 0; | // |
| } | |
| else | |
| { | |
| diffcount++; | // diff is same. |
| if(diffcount > 50) | // How many times has it |
| | been |
| == | |
| { | |
| run = 0; | // more than X so terminate |
| | run. |
| } | |
| } | |
| dothrfollow( ); | |
| tdiff = average − threshold; | |

```
        pc = ((float)tdiff/(float)average) * 100;
        printf(“count = %d\taverage = %llu\tratio = %f%%\ttdiff =
%lld\n”, count, average, pc, tdiff);
    }while (run);
}
void doaverage(void)
{
    // Average
    //~ avg[sx] = avg[sx]*(setup.filter/0x10000) + mes[sx]*
    (1−setup.filter/0x10000);
    average = average * FILTER;
    average = average >>= 16;
    temp2 = measurement * (signed)(F − FILTER);
    average += (temp2 >>= 16);
}
// Threshold follows measurement
// factor thr
void dothrfollow(void)
{
    //~ thres = thres * (setup.adapt/0x10000) + avg *
(setup.thr/0x10000) * (1− setup.adapt/0x10000);
    temp1 = ADAPT * threshold;
```

| | |
|---|---|
| threshold = (temp1 >>= 16); | // /0x10000 |
| temp2 = average * THRES; | |
| temp2 = (temp2 >>= 16); | // /0x10000 |

```
    temp3 = temp2 * (unsigned short)(0-ADAPT);
    temp3 = (temp3 >>= 16);
    threshold += temp3;
}
```

By performing such functions, the system can be tuned by adjusting smoothing parameters and the key threshold offset in order to perform the following.

Rejection of Dynamic Events, such as Flowing Water

FIG. 6 is a chart showing how dynamic events such as water flowing over the device 10, 40 can be rejected. In the Figure, time could be said to be on the x-axis.

Dashed line 60 represents the count curve, which is the raw oscillator count 30 from each of the oscillators. The dotted line 62 represents the smoothed ‘Averaged Curve’. The solid line 64, on the other hand, represents the smoothed and offset Key Threshold curve, which is smoothed over a longer time frame that the averaged curve 62. A key detection occurs when the dotted line 62 drops below the solid line 64.

More specifically, as can be seen at the left hand side of the graph of FIG. 6, the count curve 60 drops below the key threshold line 64 at regular intervals. With prior art capacitive touch systems this would cause a key-detection. However, by smoothing the count curve line 60 to the averaged curve line 62, it will be seen that detection based on the averaged curve line 62 crossing the key threshold 64 does not cause triggering. In other words, the flowing water over the front surface 14 of the substrate 12 device 10, 40 does not cause the averaged curve line to go below the threshold line 64 and thus will not trigger a key detection. The key threshold line 64 will also adapt to the flowing water by itself being readjusted over time and is set at a predetermined level below the averaged line 62 under not transient conditions.

When a user seeks to ‘press a button’ the user's finger causes a more significant change in the capacitance of the pads 18 and thus of the oscillator count 30, as can be seen in the right hand side of FIG. 6. This change in capacitance will alter the shape and values of the averaged curve 62 which will cause it to pass beyond the threshold line 64 and thus cause a determination of a triggering event (that is of a key press). The key threshold curve 64 will also vary in time with the key depressions but as this is smoothed more greatly than the averaged curve 62, this will not prevent the averaged curve 62 from crossing the threshold line 64 and thus triggering the determination of a key depression.

### Water Environment Adaption

Referring now to FIG. 7, there is shown an example of oscillator output curves caused by a change in the static conditions of the device 10, 40, such as by the appearance of standing water or high humidity on the surface 14 of the substrate 12.

The dashed line 70 again represents the actual oscillator count 30. Being what could be described as a static change in the capacitance of the pads 18, the actual oscillator count 70 incurs a step change. The averaged curve 72, that is the dotted line, will vary in like manner to the actual count line 70, albeit with a slight time delay and in smoothed form. The threshold line will also exhibit a step change in its shape, again slightly delayed as a result of its greater smoothing. However, the change in the lines 72 and 74 is such as to ensure that the averaged curve line 72 does not cross the threshold line 74 and thus the microcontroller does not determine any key pressing event.

In other words, when standing water lands on the key, it is disregarded and will have no bearing on key presses. If it drains off, the key threshold adapts accordingly, so that sensitivity to fingers does not change.

### Temperature Chance Adaption

Temperature changes also affect the speed of the oscillators 22. The above system feature ensures that the devices 10, 40 adapt automatically to temperature variations, meaning the key threshold 64, 74 tracks temperature changes. High sensitivity can be maintained.

### Local Oscillators Maximise Touch Sensitivity

Some known tough pad technology detects the capacitance change within the microcontroller. The embodiments taught herein, on the other hand, use local oscillators 22 which reside underneath the touch pad 18 to sense the capacitance. This has two primary advantages.

First, it maximises changes in oscillation due to a finger press and minimises noise variations in oscillations. The result is that the key-threshold can be set closer to the Averaged Curve, safe in the knowledge that other factors are less likely to trigger a key detection. This either results in a more sensitive key for the user, the ability to place the key behind greater thicknesses of substrate, and the ability for the user to operate the system wearing gloves.

Secondly, it also allows the sensors 18, 22 to be placed at much further distances from the microcontroller 26, since the signal between the two components is digital and therefore does not affect the sensitivity of the pad 18.

### Reset Feature

In the preferred embodiment, the system includes a reset feature, which when the environment changes dramatically, causing multiple key activations, after a period of time, the microcontroller will presume this is the norm and shift the key thresholds to those new levels.

Derivation of Finger position

Using the individual capacitive pads 18, it is possible to determine real-time finger 28 position using the count information from each oscillator 22, the pad 18 size and location information. These values are then processed by the microcontroller 26 in order to derive the finger position, as well as the time domain, in order to determine a finger movement vector. Finger gestures can thus be derived.

An example is shown in FIG. 8. In the first position, shown in FIG. 8A, the user's finger 28 is wholly over the first capacitive pad 18, which produces a low oscillator count, whereas the second capacitive pad 18′ will still produce a higher oscillator count, as can be seen in the table.

When the user slides his/her finger 28 across the pads, as this reaches the middle of the two pads 18, 18′, as shown in FIG. 8B, the oscillator count for both pads is at a medium level, allowing the microcontroller 26 to determine that the user's finger is between the pads 18, 18′. As the user's finger 28 continues to move, the counts from each oscillator on each will incrementally change, one up and one down, as the finger 28 passes to be over the second pad 18′ only, as shown in FIG. 8C. This change in oscillation frequency allows the microcontroller to determine direction of movement of a user's finger and thus to provide an additional control input to the device 10, 40 based upon finger movement and, as desired, the nature of that movement.

### Automated Learning of Thresholds

Since the touch technology taught herein can be installed in different ways, it is not possible to predict the best key threshold settings for any particular installation. As a result of this, the microcontroller 26 can be set up to learning and storing the best settings for any particular implementation.

A first method involves the user entering a predetermined pattern of key presses in order for this pattern to be recognised by the system as a user input, that is instead of noise or water interference. This pattern can then form the basis of recognising the response of the oscillators 22 to finger presses. The system can then respond using a form of output sequence, such as flashing lights, and the user can confirm with a further optional key press.

Another method involves the system recognising correct threshold settings by noticing the point at which the user stops operating the system, since this point would suggest a desired response has been reached. For example, if the user wants to power on a light, they would press the appropriate ‘button’. If the threshold is wrong, the light may not be turned on, but the system could adjust the threshold. The user would re-try and with the new threshold setting, the system may recognise the request and turn on the light. Based on this response, the user will stop attempting key-presses and the microcontroller 26 can store the current threshold setting.

### Application Specific Key-Threshold Changes

It is possible to improve key detection by changing the individual thresholds of a key according to what is expected at an application level. For example, if an option button is pressed, there may only be two key presses possible in the application. The thresholds can be adjusted accordingly in order to reject detection of any other keys, as well as to enhance the sensitivity of keys likely to be pressed.

Another variation on this is the use of timeouts on keys. For example, in the situation where there is a button in the middle of a wheel configuration, it is possible to reject any presses of the button for a period of time where it is recognised the wheel is being used.

### Shape-Recognition Key Detection

It is possible for the key detection to be performed or enhanced by means of shape recognition algorithms. The firmware will attempt to emulate the way we humans would recognise a key press (input) if we were to look at the graph. It is known that threshold-based algorithms sometimes miss key presses that a human looking at the graph could have recognised.

Shape recognition algorithms operate to detect whether or not a particular signal matches a predetermined shape, within predetermined tolerances and in known conditions.

One specific embodiment of a shape recognition algorithm utilises shape windows to create the predetermined shape to which the signal is compared. A shape window is an area on a signal/time plot which corresponds to an expected signal shape. A signal falling within the limits of the window is deemed to be acceptable, whereas a signal entering a portion of the plot which is “blocked off”, therefore not forming a part of the window, is deemed to be indicative of a false event.

In one example, the processor stores the last 10 measurements and compares the signal to a shape window. A different shape window is used for key press events than that used for key release events.

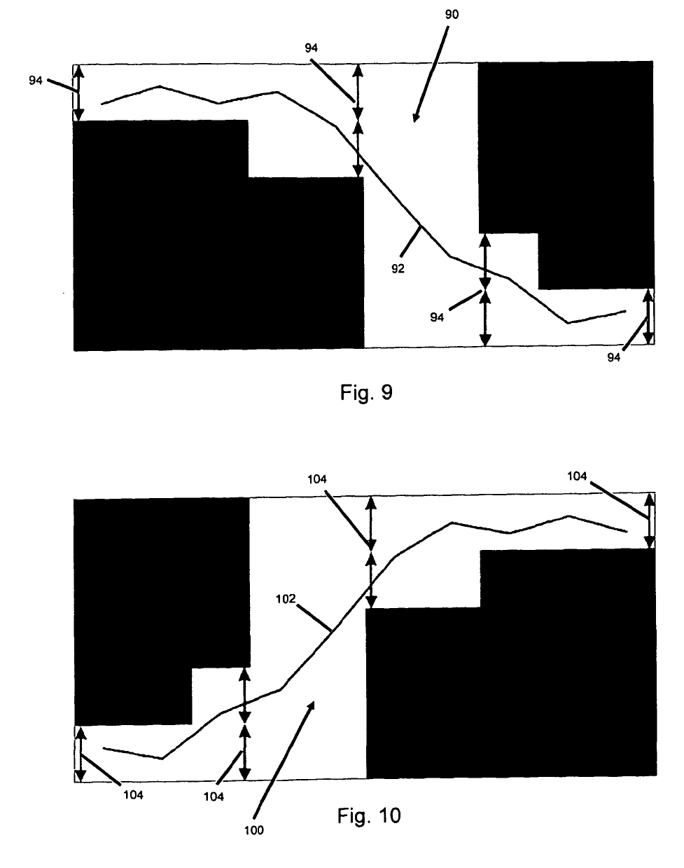

Key presses are detected by comparing the signal to the window 90 shown in FIG. 9. The line 92 shows an example set of measurements that would pass the test and would be decoded as valid key presses. The arrows 94 show the programmable “shape threshold” parameter.

Similarly, key releases are detected by comparing the signal to the window 100 shown in FIG. 10. As with FIG. 9, the line 102 shows an example set of measurements that would pass the test and would be decoded as valid key presses. The arrows 104 show the programmable “shape threshold” parameter.

Such an algorithm'would be used only when a signal is greater than a defined magnitude threshold. It would then be compared with an expected shape window for a key press event, and likewise a shape window for a key release event.

### Shape-Recognition Noise Rejection

It is possible for noise rejection to be performed or enhanced by means of shape recognition algorithms. The noise content of the signal would be defined by an algorithm such as

sum(i=1 . . . 9)(abs(m[i]−m[i+1])/(max(i=1 . . . 10)(m[i])−min(i=1 . . . 10)(m[i]))*100H

The threshold levels are configurable.

If the noise content of the signal is over “noise threshold 1” then it is not suitable for processing, and it is discarded. If “noise threshold 1” is left at its default 180 H value, this eliminates single spikes and very short key presses.

If the noise content of the signal is over “noise threshold 2”, then decoding is stopped for noise lock periods. This can be used to recognise and reject noise patterns caused by GSM telephones.

Thus, on detecting a signal which matches a defined noise signature, key press detection can be suppressed for a definable period of time subsequent to the noise event.

### Firmware Rejection of EMI Noise

As a result of the nature of local oscillators and digital signals, it is possible under certain circumstances that EMI noise such as from a GSM mobile phone may cause interference.

It is possible to reject this interference by recognising and filtering the distinct patterns. Under all circumstances, fingers 28 or other inputs cause the rate of oscillation of the sensor to decrease. In contrast, EMI noise causes apparent additional counts to the oscillators 22. It is therefore possible to recognise the reject the EMI noise in firmware by rejecting increases in oscillator count.

In the preferred embodiment this will be implemented by the microcontroller by way of an AND operation based on the differentiation against time of the oscillator count number, and whether the count number is larger than the derived threshold line value added to the Threshold variable. This will distinguish it from the rising edge of a finger 28 being removed from a valid pressed key.

In another variation, it would be possible to add to the circuit board 20 a receiving antenna (not shown) specifically designed to detect EMI interference and coupled to the microcontroller 26 to cause this to adapt or reject the detection of key-presses accordingly.

### Rejection of On-Board RF Transmitters

In configurations where a system contains RF transmission, such as 433 MhZ, Bluetooth, ZigBee, 802.11 etc., it is possible to disable the keys for the period of transmission, since the microcontroller 26 will control both RF transmission and key scanning. This prevents false key detection due to RF interference.

### Reference Oscillator

By using an oscillator which has no capacitive pad, it is possible to isolate the effect on the oscillators 22 of temperature variations and power fluctuations. The microcontroller 26 can then calibrate the values received from the other.

Synchronisation of Scanning with AC Derived Circuits

When system power is derived from an AC source and converted to DC, there will be a residual AC component which can affect the performance of the oscillators 22. The system can use a synchronisation pulse from the original AC source in order to ensure that the oscillators 22 are scanned completely in synchronisation with the source. When this is done, it negates the effect of the AC component on the DC power.

### Locking and Unlocking the Keys

In certain situations, where constant water-rejection is impossible for instance, it may be necessary to prohibit the function of the keys and for the user to enable the keys using a particular known combination of key-presses. One example may be a swipe across three keys within a predetermined time period and in a given direction.

Thus, the preferred system includes a function to lock the key pad when a possible malfunction is detected as a result of particular environmental conditions and an unlocking function enacted.

### Power Reduction

The microcontroller 26 is in the preferred embodiment set up to alter the scan characteristics in order to reduce the power consumption of the system. For example, if no key presses are detected after a given period, the microprocessor 26 could implement a 200 ms interval in between scans and go to a low power sleep mode, thus saving power. It is also possible to alter the duration of the scan per key or the number of keys that are scanned.

In another implementation, a secondary lower power sensor type can be used in order to detect the presence of a user. For example a light-based proximity sensor or piezo sensor would wake up the microcontroller 26 in order to activate the key scanning.

The benefit of this would be to enable the use of the technology in battery-powered implementations.

### Note on Edge Detection

In some embodiments it may be desired to detect standing water on the device 10, 40. For this purpose, it, may be desired to use an edge sensor, in the form of a guard rail. The edge sensor would detect standing water at the borders of the substrate 12 and lock the buttons for a period of time, while the edge detector is activated. This may be implemented in hardware or software.

1. A device including a capacitive touch pad provided with at least one capacitive element for providing a control input to the device; and an oscillator associated with the or each capacitive element; wherein a change in capacitance at the capacitive element causes a change in oscillation frequency; the system including a control unit operable to measure the oscillation frequency of the or each oscillator; wherein the control unit is operable to derive a rolling average of the oscillator count, to derive a rolling average key threshold obtained from the rolling average of the associated oscillator count, to compare said rolling average oscillator count to said rolling average key threshold, and to determine therefrom whether an input has been effected.

2. (canceled)

3. A device according to claim 1, wherein the oscillator operates at a free running frequency of approximately equal to or greater than 8 MHz.

4. A device including a capacitive touch pad provided with at least one capacitive element for providing a control input to the device; and an oscillator associated with the or each capacitive element and operating at a free running frequency of approximately equal to or greater than 8 MHz; wherein a change in capacitance at the capacitive element causes a change in oscillation frequency; the system including a control unit operable to measure the oscillation frequency of the or each oscillator; wherein the control unit is operable to derive a rolling average of the oscillator count, to compare said rolling average oscillator count to a threshold, and to determine therefrom whether an input has been effected.

5. A device according to claim 1 or 4, wherein the control unit is operable to produce a variable threshold.

6. A device according to claim 4, wherein the control unit is operable to produce a variable threshold obtained as a rolling average of the associated oscillator count.

7. A device according to claim 6, wherein the rolling average of the variable threshold is derived from the rolling average of the oscillator count.

8. A device according to claim 1 or 4, wherein the or each oscillator is located adjacent to the or its respective capacitor pad and including a printed circuit board upon which the or each capacitor pad is located, the or each associated oscillator being coupled to the same circuit board as its respective capacitive pad.

9. (canceled)

10. A device according to claim 1 or 4, wherein the control unit is operable to determine an input based upon a change in capacitance at a plurality of capacitive pads of the device by determining a change in oscillation frequency of the associated oscillators.

11. A device according to claim 1 or 4, wherein the control unit is operable to detect the occurrence of inputs over a predetermined period of time and to lock further determination of inputs when a threshold of inputs within a preset period has been detected and to unlock further determination of inputs upon the actuation of a predetermined unlocking input or input sequence.

12. A device according to claim 1 or 4, comprising at least two oscillators and wherein the control unit is operable to sum at least some of the oscillator counts, to determine whether or not said sum has exceeded a threshold, and the lock the device in the event that said sum exceeds the predetermined threshold, wherein the control unit is operable to lock the device for a predetermined period of time in the event that said sum exceeds the predetermined threshold.

13. (canceled)

14. A device according to claim 1 or 4, wherein the control unit is operable to derive an indication of movement of an input actuator and wherein the input actuator is a user's finger and the movement is movement of the user's finger.

15. (canceled)

16. A device according to claim 1 or 4, wherein the control unit is operable to determine the threshold on the basis of measurement of the oscillator count generated by a predetermined input to the device and wherein the predetermined input is a sequence of inputs events.

17. (canceled)

18. A device according to claim 1 or 4, wherein the control unit is operable to adjust the threshold upon a determination that a user input has been effected and/or wherein the control unit is operable to block determination of user inputs in respect of any inputs incompatible with a specific application or function of the device and/or wherein the control unit is operable to determine a synchronisation pulse from an AC power supply to the device.

19. (canceled)

20. A device according to claim 1 or 4, including means to reject electromagnetic interference, wherein the means for rejecting electromagnetic interference rejects increases in oscillator frequency determined by the control unit and/or including an antenna operable to detect electromagnetic waves.

21. (canceled)

22. (canceled)

23. A device according to claim 1 or 4, including means for transmitting sensor determinations, wherein the control unit is operable to disable the sensing of the capacitance of the touch pad during periods of transmission and/or including a reference oscillator and/or including at least one locking key or locking function and/or including an edge detector operable to detect water on the device.

24. (canceled)

25. (canceled)

26. (canceled)

27. A device according to claim 1 or 4, wherein the control unit is operable to perform or enhance the determination of an input by means of a shape recognition algorithm, wherein the control unit is operable to compare the signal with an expected shape window for a key press event and/or wherein the control unit is operable to compare the signal with an expected shape window for a key release event and/or wherein the shape recognition algorithm is used only when the signal is greater than a defined magnitude threshold.

28. (canceled)

29. (canceled)

30. (canceled)

31. A device according to claim 1 or 4, wherein control unit is operable to perform or enhance noise rejection by means of a shape recognition algorithm, wherein key press detection is suppressed upon detection of a signal matching a defined noise signature, wherein key press detection is suppressed for a predetermined period of time subsequent to the detection of a signal matching a defined noise signature.

32. (canceled)

33. (canceled)

34. (canceled)

35. A device according to claim 1 or 4, wherein the rolling average is taken over a time period in the range of 20 ms to 500 ms.

36. A device according to claim 25, wherein the rolling average is taken over a time period of 100 ms.

37. A device including a capacitive touch pad, including a substrate that comprises at least one capacitive pad located at an inner surface of the substrate and an oscillator located adjacent to the or each capacitive pad.

38. A method of operating a device including a capacitive touch pad provided with at least one capacitive element for providing a control input to the device; and an oscillator associated with the or each capacitive element; wherein a change in capacitance at the capacitive element causes a change in oscillation frequency; the system including a control unit operable to measure the oscillation frequency of the or each oscillator; wherein the method includes the steps of operating the control unit to derive rolling average of the oscillator count, operating the control unit to derive a rolling average key threshold obtained from the rolling average of the associated oscillator count, operating the control unit to compare said rolling average oscillator count to said rolling average key threshold, and operating the control unit to determine therefrom whether an input has been effected.

39. A method of operating a device including a capacitive touch pad provided with at least one capacitive element for providing a control input to the device; and an oscillator associated with the or each capacitive element; wherein a change in capacitance at the capacitive element causes a change in oscillation frequency; the system including a control unit operable to measure the oscillation frequency of the or each oscillator; wherein the method includes the steps of operating the oscillator at a free running frequency of approximately equal to or greater than 8 MHz, and operating the control unit to derive a rolling average of the oscillator count, to compare said rolling average of the oscillator count to a threshold, and to determine therefrom whether an input has been effected.
